(19) United States
(12) Patent Application Publication
(10) Pub. No.: US 2005/0050186 A1
(43) Pub. Date: Mar. 3, 2005

(54) Network-linked computer platform configuration data access management method and system

(76) Inventor: Chih-Wei Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/653,327

(22) Filed: Sep. 2, 2003

(51) Int. Cl. G06F 15/173; G06F 7/00; G06F 17/30

(52) U.S. Cl. 709/223; 707/10

(57) ABSTRACT

A network-linked computer platform configuration data access management method and system is proposed, which is designed for use with a network-linked computer platform, such as an Internet-linked Web server or the like, and which is capable of allowing a group of system administrators to browse the configuration data of each management function of the Web server at the same time while allowing only one system administrator, and not two or more, to modify the configuration data of the same management function at the same time. This feature can help prevent conflict of configuration data in the Web server that would otherwise cause abnormal operation or even system crash to the Web server.

### BACKGROUND OF THE INVENTION

1. Field of the Invention

This invention relates to network-based information technology, and more particularly, to a network-linked computer platform configuration data access management method and system which is designed for use with a network-linked computer platform, such as an Internet-linked Web server or the like, and which is capable of allowing a group of system administrators to browse the configuration data of each management function of the Web server at the same time while allowing only one system administrator, and not two or more, to modify the configuration data of the same management function at the same time, for the purpose of preventing conflict of configuration data in the Web server that would otherwise cause abnormal operation or even system crash to the Web server.

2. Description of Related Art

Web server is a network-linked computer platform that is permanently linked to a network system, such as Internet, to provide Web page services to remote clients via the Internet. In addition, system administrators can also use a network-linked workstation to remotely perform system management or maintenance tasks on the Web server. These system management or maintenance tasks include, for example, inputting authorized user profiles, configuring hard disks, setting system security levels, and so on. In general, each Web server in a corporate environment is typically supervised by more than one system administrators, and all of whom are authorized to gain access to the existing configuration data of each management function of the Web server so as to browse or modify the contents thereof.

One drawback to conventional Web server management systems, however, is that all of the system administrators are allowed to gain access to and modify the configuration data of the same management function of the Web server at the same time, which would easily cause conflict of configuration data in the Web server that could then cause abnormal operation or even system crash to the Web server.

### SUMMARY OF THE INVENTION

It is therefore an objective of this invention to provide a network-linked computer platform configuration data access management method and system that allows a group of system administrators to gain access to and browse the configuration data of the same management function of a network-linked computer platform at the same time while allowing only one system administrator, and not two or more, to modify the configuration data of the same management function at the same time, for the purpose of preventing conflict of configuration data in the network-linked computer platform that would otherwise cause abnormal operation or even system crash to the network-linked computer platform.

The network-linked computer platform configuration data access management method and system according to the invention is characterized by the provision of a table data module to store the current-access-status property of each individual management function of the network-linked computer platform; and whenever a management function access request is received from a remote workstation, the table data module is inquired to check whether the management function being requested for modification is currently being accessed; if NO, an access-permit message is issued to permit the system administrator at the remote workstation to gain access to and modify the configuration data of the management function; whereas if YES, an access-inhibit message is issued. This feature allows the configuration data of the same management function of the network-linked computer platform to be modified by just one system administrator, and not two or more, at the same time so that it can help prevent conflict of configuration data in the network-linked computer platform that would otherwise cause abnormal operation or even system crash to the network-linked computer platform.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture and object-oriented component model of the network-linked computer platform configuration data access management system according to the invention; and

FIG. 2 is a table showing an example of a table data module used to store the current-access-status property of each management function of the Web server employing the invention.

### DETAILED DESCRIPTION OF PREFERRED EMBODIMENTS

The network-linked computer platform configuration data access management method and system according to the invention is disclosed in full details by way of preferred embodiments in the following with reference to the accompanying drawings.

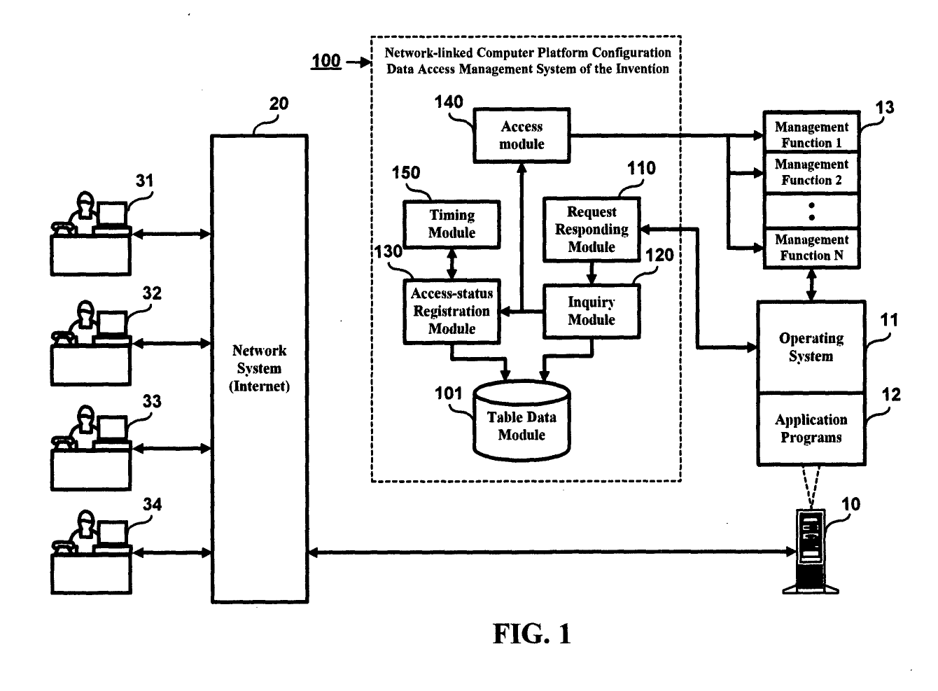

FIG. 1 is a schematic diagram showing the application architecture and object-oriented component model of the network-linked computer platform configuration data access management system according to the invention (as the part enclosed in the dotted box indicated by the reference numeral 100). As shown, the network-linked computer platform configuration data access management system of the invention 100 is designed for use with a network-linked computer platform, such as a Web server 10, that is provided with a set of server-related management functions 13 and is permanently linked to a network system 20, such as Internet, to allow one or more system administrators to use workstations 31, 32, 33, 34 to link via the network system 20 to the Web server 10 and use a browser program, such as Microsoft Internet Explorer or Netscape Navigator, to gain access to and browse the configuration data of each of the management functions 13 of the operating system 11 and application programs 12 installed on the Web server 10. The management function configuration data include, for example, authorized user profiles, hard disk settings, system security settings, and so on. The network-linked computer platform configuration data access management system of the invention 100 is capable of allowing all of the system administrators to browse the contents of the configuration data of any one of the management functions 13 on the Web server 10 at the same time while allowing only one system administrator, and not two or more, to modify the configuration data of the same management function at the same time, for the purpose of preventing conflict of configuration data in the Web server 10 that would otherwise cause abnormal operation or even system crash to the Web server 10.

The network-linked computer platform configuration data access management system of the invention 100 comprises: (a) a table data module 101; (a) a request responding module 110; (b) an inquiry module 120; (c) an access-status registration module 130; and (d) an access module 140; and further optionally includes a timing module 150.

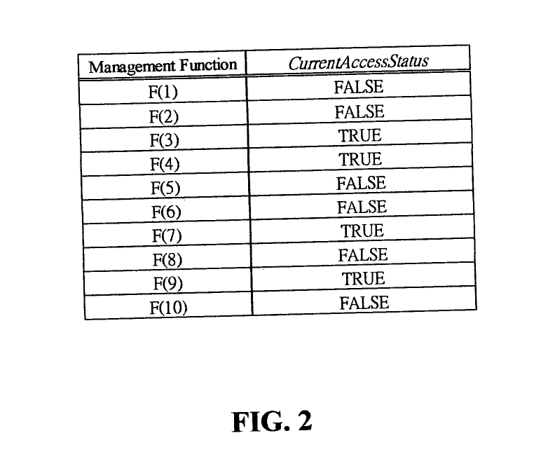

The table data module 101 is a data-only module used to store the current-access-status property of each of the management functions 13 of the Web server 10. These management functions 13 are here represented, for example, by F(1), F(2), . . . , F(N). An example of the table data module 101 is shown in FIG. 2. In the table data module 101, the first column stores F(1), F(2), . . . , F(N), while the second column stores the current-access-status property (represented by CurrentAccessStatus) of each management function as either TRUE or FALSE. For example, if F(i).CurrentAccessStatus=FALSE, it indicates that the management function F(i) is currently being unaccessed by any system administrator; whereas if F(i).CurrentAccessStatus=TRUE, it indicates that the management function F(i) is currently being accessed (only by one system administrator) and is thus inaccessible to any other system administrators. At initialization, the CurrentAccessStatus properties in the table data module 101 are all set to FALSE.

In certain cases, the management functions F(1), F(2), . . . , F(N) 13 may each further include a group of subset functions. In practical implementation of the invention, the subset functions of each management function can be individually assigned to have their own CurrentAccessStatus properties, i.e., each subset function has its own CurrentAccessStatus property different from other subset functions in the same management function. This scheme allows different subset functions in the same management function to be accessible and modified by different system administrators at the same time. Alternatively, all the subset functions of the same management function can be collectively assigned to have the same CurrentAccessStatus property. This scheme allows just one system administrator to gain access to and modify the configuration data of all the subset functions in the same management function. In other words, if a certain subset function of a management function is currently being accessed and modified by a certain system administrator, then all the other subset functions of that management function will be inaccessible for modification by any other system administrators.

The request responding module 110 is capable of detecting via the operating system 11 whether any one of the system administration workstations 31, 32, 33, 34 currently being linked to the computer platform 10 has issued a management function access request to the Web server 10; and if YES (assume that the requesting workstation is the workstation 31), the request responding module 110 will promptly issue an inquiry request message to the inquiry module 120.

The inquiry module 120 is capable of being activated in response to the inquiry request message from the request responding module 110 to inquire the table data module 101 whether the management function being requested for access by the requesting workstation 31 is currently being accessed for modification, i.e., to check whether the CurrentAccessStatus property of the requested management function is FALSE or TRUE; if FALSE, the inquiry module 120 will promptly issue an access-permit message; whereas if YES, the inquiry module 120 will issue an access-inhibit message.

The access-status registration module 130 is capable of being activated in response to the access-permit message from the inquiry module 120 to change the CurrentAccessStatus property of the requested management function from FALSE to TRUE. This action causes the requested management function to be inaccessible to any other system administrators.

The access module 140 is capable of being activated in response to the access-permit message from the inquiry module 120 to allow the requesting workstation 31 to gain access and modify the configuration data of the management function, and also capable of being activated in response to the access-inhibit message from the inquiry module 120 to inhibit the requesting workstation 31 to modify the configuration data of the management function. The access module 140 can be implemented in such a manner as to inhibit the system administrator to browse and modify the contents of the configuration data of the requested management function, or in such a manner as to just inhibit the system administrator to modify the contents but allow the system administrator to view the contents thereof.

The timing module 150 is an optional module, which is capable of being activated to count time for a preset timeout length promptly after the access module 140 is activated to allow the requesting workstation 31 to gain access to and modify the configuration data of the requested management function, and which is further capable of generating an access-inhibit message at timeout to disable the access module 140 and reset the CurrentAccessStatus property of the requested management function back to FALSE in the table data module 101.

During actual application, assume the system administration workstation 31 issues a configuration data modification request for a particular management function of the Web server 10 via the network system 20 to the Web server 10. This request will be detected by the request responding module 110, which then responsively issues an inquiry request message to the inquiry module 120. In response to the inquiry request message, the inquiry module 120 promptly inquires the table data module 101 whether the management function being requested for modification by the requesting workstation 31 is currently being accessed for modification by any other person, i.e., to check whether the CurrentAccessStatus property of the requested management function is FALSE or TRUE; if FALSE, the inquiry module 120 will promptly issue an access-permit message; whereas if YES, the inquiry module 120 will issue an access-inhibit message.

In the event of an access-inhibit message, it will inhibit the access module 140 to allow the system administrator at the requesting workstation 31 to modify the configuration data of the management function, but only allow the system administrator to view the contents thereof.

In the event of an access-permit message, it will first enable the access-status registration module 130 to change the CurrentAccessStatus property of the requested management function from FALSE to TRUE, and then enable the access module 140 to allow the requesting workstation 31 to gain access to and modify the configuration data of the requested management function.

As the access module 140 is enabled for the system administrator at the requesting workstation 31 to modify the configuration data of the requested management function, the timing module 150 is also activated to count time for a preset timeout length. At timeout, the timing module 150 will promptly generate an access-inhibit message to disable the access module 140 and reset the CurrentAccessStatus property of the requested management function to FALSE in the table data module 101. This action is intended to allow each system administrator to perform modification to the configuration data of a particular management function only for a limited period of time.

In conclusion, the invention provides a network-linked computer platform configuration data access management method and system, which is characterized by the provision of a table data module to store the current-access-status property of each individual management function of the network-linked computer platform; and whenever a management function access request is received from a remote workstation, the table data module is inquired to check whether the management function being requested for modification is currently being accessed; if NO, an access-permit message is issued to permit the system administrator at the remote workstation to gain access to and modify the configuration data of the management function; whereas if YES, an access-inhibit message is issued. This feature allows the configuration data of the same management function of the network-linked computer platform to be modified by just one system administrator, and not two or more, at the same time so that it can help prevent conflict of configuration data in the network-linked computer platform that would otherwise cause abnormal operation or even system crash to the network-linked computer platform.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A network-linked computer platform configuration data access management method for use on a network-linked computer platform that is provided with at least one management function and linked to a network system linked to a number of system administration workstations, for the purpose of allowing a group of system administrators to browse the configuration data of each management function of the network-linked computer platform at the same time while allowing only one system administrator to modify the configuration data of the same management function at the same time;
the network-linked computer platform configuration data access management method comprising:
establishing a table data module, which is a data-only module used to store the current-access-status property of each management function of the network-linked computer platform;
in the event of any one of the system administration workstations issues a management function access request, inquiring the table data module whether the management function being requested for modification is currently being accessed; if NO, generating an access-permit message; whereas if YES, generating an access-inhibit message;
in response to the access-permit message, performing an access-status registration procedure to set the current-access-status property of the requested management function to TRUE in the table data module; and then permitting the requesting workstation to gain access to and modify the configuration data of the requested management function; and
in response to the access-inhibit message, performing an access-inhibiting procedure to inhibit the requesting workstation to modify the configuration data of the requested management function.

2. The network-linked computer platform configuration data access management method of claim 1, further comprising:
a timing procedure, which is capable of being activated to count time for a preset timeout length promptly after the system administrator at the requesting workstation starts modifying the configuration data of the requested management function, and which is further capable of generating an access-inhibit message at timeout to inhibit access to the configuration data of the requested management function.

3. The network-linked computer platform configuration data access management method of claim 1, wherein the management function configuration data includes authorized user profiles, hard disk settings, and system security settings.

4. The network-linked computer platform configuration data access management method of claim 1, wherein the access-inhibiting procedure allows the system administrator at the requesting workstation to view the contents of the configuration data of the requested management function but not to modify.

5. A network-linked computer platform configuration data access management system for use with a network-linked computer platform that is provided with at least one management function and linked to a network system linked to a number of system administration workstations, for the purpose of allowing a group of system administrators to browse the configuration data of each management function of the network-linked computer platform at the same time while allowing only one system administrator to modify the configuration data of the same management function at the same time;
the network-linked computer platform configuration data access management system comprising:
a table data module, which is a data-only module used to store the current-access-status property of each management function of the network-linked computer platform;
a request responding module, which is capable of detecting whether any one of the system administration workstations has issued a management function access request; and if YES, capable of issuing an inquiry request message;
an inquiry module, which is capable of being activated in response to the inquiry request message from the request responding module to inquire the table data module whether the management function being requested for modification is currently being accessed; if NO, the inquiry module generating an access-permit message; whereas if YES, the inquiry module issuing an access-inhibit message;
an access-status registration module, which is capable of being activated in response to the access-permit message from the inquiry module to set the current-access-status property of the requested management function to TRUE; and
an access module, which is capable of being activated in response to the access-permit message from the inquiry module to allow the system administrator at the requesting workstation to gain access to and modify the configuration data of the requested management function, and capable of being activated in response to the access-inhibit message from the inquiry module to inhibit the system administrator at the requesting workstation to modify the configuration data of the management function.

6. The network-linked computer platform configuration data access management system of claim 5, further comprising:
a timing module, which is capable of being activated to count time for a preset timeout length promptly after the system administrator at the requesting workstation starts modifying the configuration data of the requested management function, and which is further capable of generating an access-inhibit message at timeout to inhibit access to the configuration data of the requested management function.

7. The network-linked computer platform configuration data access management system of claim 5, wherein the management function configuration data includes authorized user profiles, hard disk settings, and system security settings.

8. The network-linked computer platform configuration data access management system of claim 5, wherein the access module, when inhibited, allows the system administrator at the requesting workstation to view the contents of the configuration data of the requested management function but not to modify.
